(19) United States
(12) Patent Application Publication
(10) Pub. No.: US 2002/0195002 A1
(43) Pub. Date: Dec. 26, 2002

(54) Hot sandwich vending machine

(76) Inventors: Jose Manuel Suarez Dominguez, Ponteareas (ES); Fernando Antonio Vazquez Nunnez, Corvja (ES); Enrique Paz Domonte, Vigo (ES)

Correspondence Address: BRINKS HOFER GILSON & LIONE, P.O. BOX 10395, CHICAGO, IL, 60610, US

(21) Appl. No.: 10/155,911

(22) Filed: May 24, 2002

Related U.S. Application Data
(63) Continuation-in-part of application No. PCT/ES00/00455, filed on Nov. 24, 2000.

(30) Foreign Application Priority Data
Nov. 25, 1999 (ES) P-9902607
Nov. 23, 2000 (ES) P-200002805

(51) Int. Cl. A23L 1/00

(52) U.S. Cl. 99/357

(57) ABSTRACT

A device and methods for automatically vending hot rolls based on French bread known as a “baguette” are provided. The rolls are sealed in plastic bags, frozen, and kept refrigerated in the device. The device can automatically transfer a roll from the refrigerated compartment to an oven in order to heat and toast the roll. The user may remove the product when it is ready, but cannot access the one or more oven compartments. The device may also contain a multimedia panel that shows images of the rolls, manages the selection and shows the coinage balance.

### REFERENCE TO RELATED APPLICATIONS

This application is a continuation-in-part of PCT/ES00/00455 (Publication No. WO 01/39141), filed Nov. 24, 2000, the entire contents of which are incorporated by reference, and claims the benefit of Spanish Patent Nos. P-9902607, filed Nov. 25, 1999, and P-200002805, filed Nov. 23, 2000, which are incorporated by reference.

### OBJECT OF INVENTION

The present invention refers to a machine intended for automatically vending hot rolls based on French bread known as “baguette”. They are prefabricated rolls wrapped in a thermoresistant plastic bag and filled with inert gas, subjected to a cryogenic freezing process, refrigerated inside the machine and separated according to types in the form of vertical piles. The machine has an automatic device that is able to transfer a roll from a series of vertical piles situated in the preservation area to an infrared oven in order to heat and toast the roll. There is a mechanism that allows the user to remove the product only when it is ready and which does not allows the user access to the oven. There is a multimedia panel that shows images of the rolls, manages the selection and shows the balance. It is also used to present advertising contents and give access to user information and entertainment. It has the corresponding methods of payment.

### BACKGROUND

There are solid food vending machines based on horizontal helicoids, rotating carousels and other types of mechanisms. These machines do not heat or bake the products, they only distribute them.

There are also machines that expend hot rolls in the form of sandwiches or hamburgers. However, the latter heat the roll inside an opaque wrapping normally based on tin foil and using a hot plate, so that it is heated and not toasted, since there is no infrared radiation on its surface.

British patent no. GB 2284805 describes a vending machine in which food products stored between the spirals of vertical helicoids are refrigerated and preserved at low temperatures. When the helicoids turn, the products that are held between two consecutive helicoids fall down to the lower section, where there is a mechanism to transport them to the heating area or oven. Among other disadvantages, the machine corresponding to this British patent does not have proper insulation between the upper refrigeration area and the lower heating area when the transport mechanism tilts over, leading to the corresponding loss of energy and performance. Moreover, in the case of this British patent, the helicoids that support the products are situated without partitions to limit the number of products that pile up on each helicoid.

French patent number 2688085 describes a machine with two ovens or heating areas. In this particular case, the products enter a tilting distribution or transfer mechanism that takes them to one of the ovens on either side of the intermediate zone occupied by the aforementioned transfer mechanism. Therefore, this machine does not have proper insulation for when the transfer mechanism tilts over to transfer the product from the refrigerated storage zone to the heating area.

U.S. Pat. No. 4,286,509 describes a machine that heats up food products, i.e. hamburgers. It contains a conveyor belt for the products, which then pass by a series of heating elements situated both over and under the conveyor belt, meaning that both the top and bottom of the product are warmed. In this case, the products are placed on the belt without any means of separation between them or any mechanism to control their situation. Furthermore, there is a hatchway that tilts over when the products pass by on the continuous belt, which is fitted between rolls or pulleys.

In view of the foregoing, this present application refers to a machine for distributing or heating rolls, although the latter are not part of the invention and are readily available as common products on the market. They are distributed in various retail outlets, such as bars, cafeterias, petrol stations, etc. The application is for a solution that can perform this process automatically, with a view to deploying vending machines for this type of products.

The thermoresistant plastic used is not part of the invention either, although it is an important characteristic for the correct functioning of same. It is a transparent plastic sheet that is able to resist temperatures of up to 200° C. and that is used to make the bag holding the roll. This characteristic allows the roll to be baked without previously extracting it from its wrapping. Therefore, the manipulation process is simplified, its integrity is guaranteed, the production of waste food inside the machine is avoided and the finished product is offered inside the same bag

In short, there are patents for similar machines. In some cases, they include an area where the products are stored and refrigerated and an area where the products are heated before being extracted, whereas there are mechanisms to transfer the product from the storage and refrigeration area to the heating area. There are also machines containing conveyor belts that transfer the products to be heated towards an oven or area with heating elements. We are also aware that the machines with refrigerated areas hold the products between the consecutive of helicoidal elements, so that as they turn, the products fall one by one and are then transferred to the heating area.

### DESCRIPTION

In the machine proposed by this invention, there is a cool area like a fridge situated in the back of the machine, containing the supports where the rolls are stored and preserved. These supports consist of helicoids placed with their longitudinal axis vertically and confined between vertical walls. The distance between the adjacent profiles of a helicoid and between the walls is such that it is possible to store a roll in the resulting space, whereas the roll is situated approximately perpendicular to the longitudinal axis of the helicoid and supported on the front and back segments of the next profile. Each support has an engine that is able to turn the helicoid around its longitudinal axis, so that every time it turns around, the roll situated in the lower profiles is released and all the other rolls stored in the corresponding support are lowered. The fact of placing the helicoids vertically, with extraction on the lower part is an advantage over the horizontal method because the products do not offer any resistance to movement, but rather help the process with their own weight. Furthermore, the supports would vary if their longitudinal axis were not in line with the engine axis, so that the geared motor makes it act as a brake when it stops moving.

In the lower part of the refrigerated area, there is a combination of ramps and a mechanism intended to transport the roll that is released so that it is deposited inside an element that is able to transfer it to the cooking area. This is a cylindrical element, on whose surface and along the longitudinal axis, there is a hollow space where a roll fits. This cylinder is motorised so that when a roll is fully inside the hollow space, it is possible to rotate the cylinder to transfer the roll to the cooking area. The space existing between the cylinder and the walls of the refrigerated area is properly insulated so that the heat exchange between the refrigerated area and the cooking area is limited. The thermal insulation is also ensured by the fact that access to the cooking area is such that the hollow space may never have any part exposed to the refrigerated area and another part exposed to the cooking area.

The cooking area is composed of a metallic compartment covered in insulating material, containing a series of quartz or other similar resistors that are capable of generating heat and radiation on the infrared band. The irradiated heat is used to toast the bread and heat the inside of the roll. Optionally, metallic reflectors may also be included, intended to concentrate and ensure the uniformity of the radiation on the roll. The cooking time needed is between 2 and 3 minutes depending on the level of cooking required, the thickness of the rolls, the pre-cooked level of the bread and the power used.

As regards the shape and capacity of the cooking area, there are two options:

a) Two simple ovens. The cooking area is divided into two oven compartments. In this case, the transfer system is such that it is able to direct the hollow space to one oven or to the other. The grill upon which the roll is grilled combines with a mechanism designed so that when a door situated on the front of the machine opens, it is transferred frontally to move the roll towards the space in the door, allowing the user to remove the roll and blocking access to the oven.

b) A continuous oven. There is a continuous conveyor system inside the compartment, which is able to move various rolls simultaneously towards the delivery area situated at the front of the machine. While they are being moved, the rolls are exposed to heat and radiation. Once they reach the front of the oven, the rolls fall onto a tray from which the consumer may collect the finished product. There is an automatic flap that impedes access to the oven. In order to achieve a larger refrigerated area with a greater capacity, without reducing the height of the product, the oven conveyor system is upwardly sloped.

Although both options are operative, the second one (b) is included as the preferred embodiment as it offers a greater production capacity. However, there may be situations where a high level of production is not necessary and option (a) be chosen.

More specifically and for this second option, the oven is structured on a rack, containing a transfer unit at the postero-superior level, which is suitably motorised, moving in synchrony with a conveyor belt, also motorised, holding various trays, to collect the respective rolls, so that the transfer unit deposits every roll on one of the aforementioned trays, while also moving the latter and consequently, the rolls, before a series of infrared resistors, suitably placed on supports set on the aforementioned rack, whereas the trays move upwards at a pronounced slope, which lengthens the time they spend in front of the infrared resistors, making it at the same time possible to reduce the longitudinal dimensions of the oven and whereas the aforementioned chain ends at a practically vertical section, where the hot rolls are expelled towards the product exit. A top lid covering the heating resistors prevents the escape of heat and gases and suitably protects the oven.

As a complement to the structure here described, the oven contains a front-lower grating that allows the gases to escape. It also contains a tray for collecting breadcrumbs under the conveyor belt and a trap door at the back giving access to the aforementioned tray so it may be periodically cleaned when necessary.

### DESCRIPTION OF DRAWINGS

In order to complement this description, and with the objective of enabling better comprehension of the characteristics of the invention, in accordance with an example of the preferred embodiment of same and as an integral part of the description, we have included a set of drawings of an illustrative and non-restrictive nature, representing the following:

FIGS. 1a and 1b—Show a general view of the machine, highlighting its main components and showing its shape, in the first figure, with the door closed and in the second, with the door open and in accordance with a first variation of the embodiment in which the machine includes two simple ovens.

FIG. 2—Shows a storage support, including rolls in order to show how the latter are stored.

FIG. 3—Shows details of the hopper, the cylindrical transfer element and the lines leading to the ovens.

FIG. 4—Shows the inside of an oven, including the grill and a roll.

FIG. 5—Shows the mechanism for extracting the roll and the door.

FIG. 6—Shows a representation similar to that in Figure 1b, where the machine contains the continuous oven foreseen as the preferred embodiment for the invention.

FIG. 7—Shows, according to a schematic perspective representation, an oven for rolls etc. made in accordance with the object of the present invention.

FIG. 8—Shows a partial side-view schematic representation of the same oven.

FIG. 9—Shows a detail of the conveyor belt that participates in the oven in FIGS. 6 to 8.

FIG. 10—Shows a perspective detail of one of the supports for infrared resistors.

### PREFERRED EMBODIMENTS

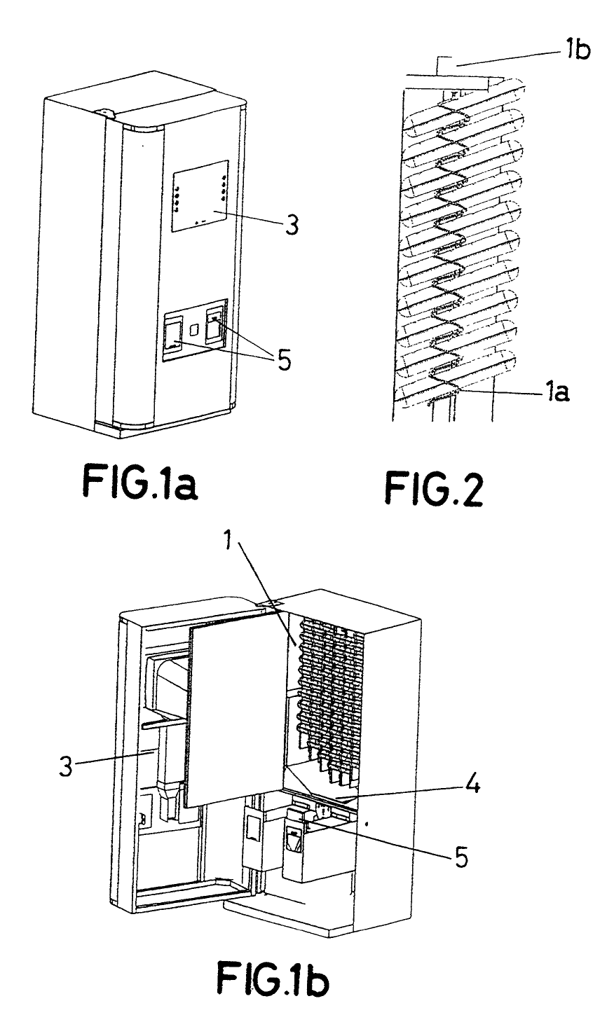

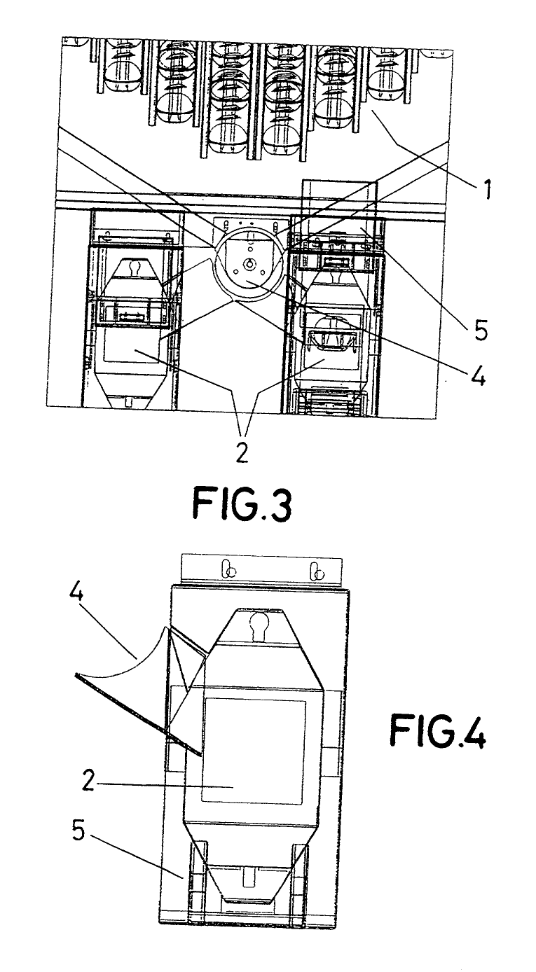

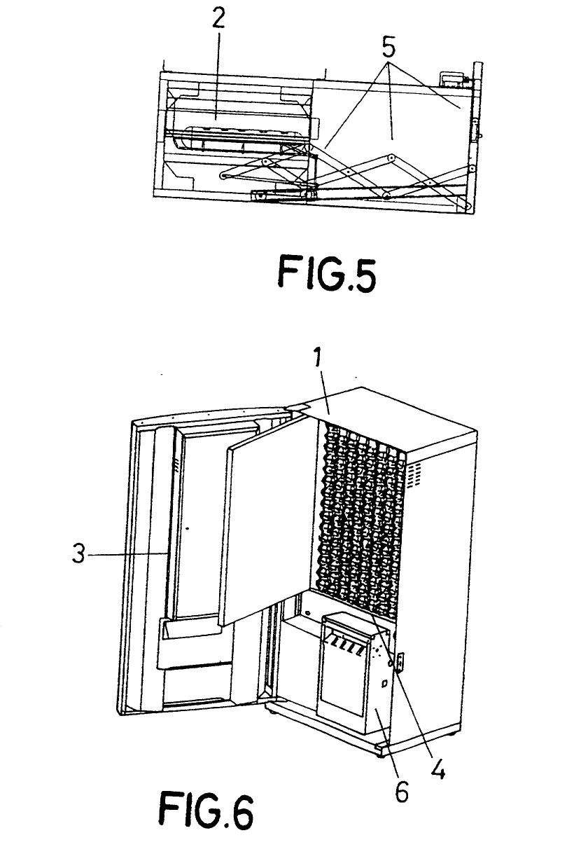

In the figures provided, especially in FIGS. 1 to 5, we may observe that the machine has a series of storage supports (1) (eight in the embodiment in the figures), formed by rigid material walls, situated in a refrigerated area, similar to a fridge, which occupies the upper back part of the machine. These supports (1) consist of helicoids (1a) placed with their longitudinal axis vertically and confined between the aforementioned sidewalls. The distance between the adjacent profiles of a helicoid and between the walls is such that it is possible to store a roll in the resulting space, whereas the roll is situated approximately perpendicular to the longitudinal axis of the helicoid and supported on the front and back segments of the corresponding profile or spiral. Each support contains a geared motor (1b) that is able to turn the helicoid around its longitudinal axis, so that every time it turns around, the roll situated in the lower profiles is released and all the other rolls stored in the corresponding support are lowered. A microswitch shows when a full circuit has been completed.

In the lower part of the refrigerated area, there is a hopper that moves each roll released from one of the storage supports (1) towards an element (4) that is able to direct it towards one of the ovens (2) foreseen in the practical embodiment in the aforementioned FIGS. 1 to 5. The surface of the hopper is smooth and slippery, thereby allowing the rolls to roll or slip down its walls towards the aforementioned element (4), of a cylindrical configuration, with an axis perpendicular to that of the helicoids. The cylindrical element (4) combines with the axis of a geared motor allowing it to turn to one side or the other, to move the roll towards one of the ovens (2). Two end stops show if the existing space in the rotating element is situated towards the storage area, towards the line to the left oven or the line to the right oven. This space should of course be formally and dimensionally suitable to hold a roll.

The walls of the ovens are made of diffuse metallic material and their shape is such that the rays reflected on same fall on the roll in a uniform manner.

The doors of each of the ovens have a solenoid that allows us to release them and an end stop that lets us know if they are closed or open.

Once the roll falls onto a grill situated inside the oven (2), it is subjected to infrared radiation provided by conventional resistors. The oven is designed so that the roll receives uniform radiation. The time and the cycles for exposure to the radiation are set so that the bread finishes cooking and is toasted, while the content of the roll is warmed at the same time.

The grill on which the roll is cooked is combined with a mechanism (5) designed so as when a door situated on the front of the machine is opened, it moves to transfer the roll to the resulting space, allowing the user to remove the roll and blocking access to the oven.

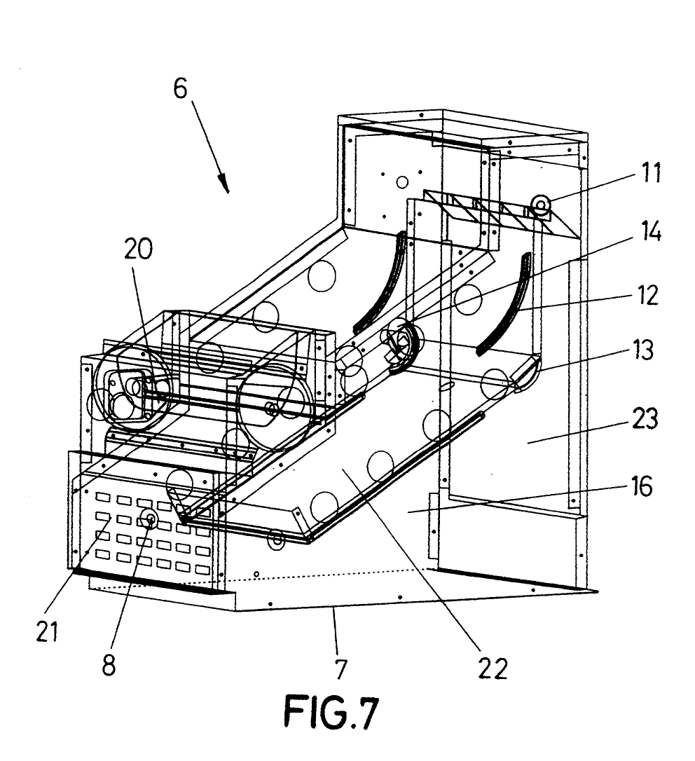

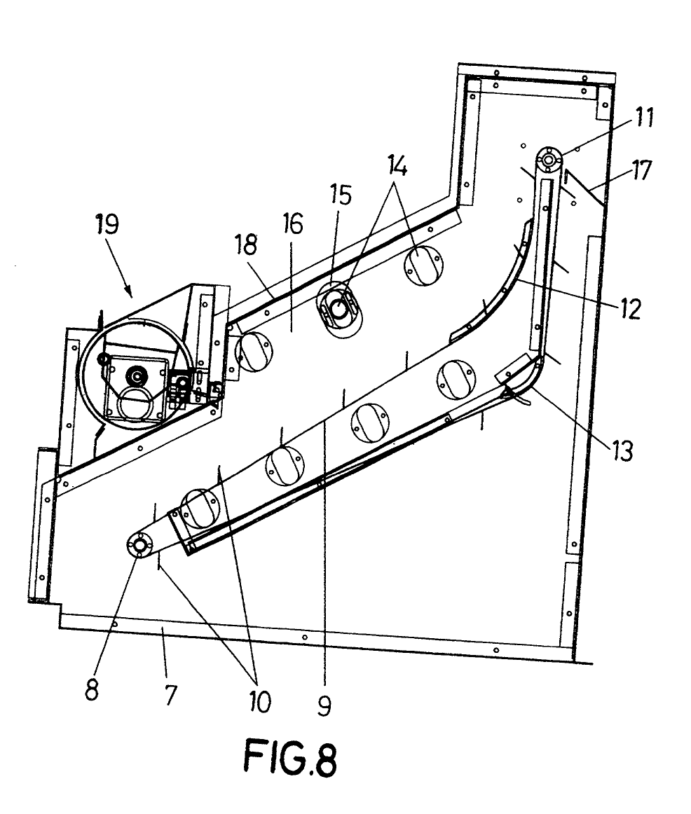

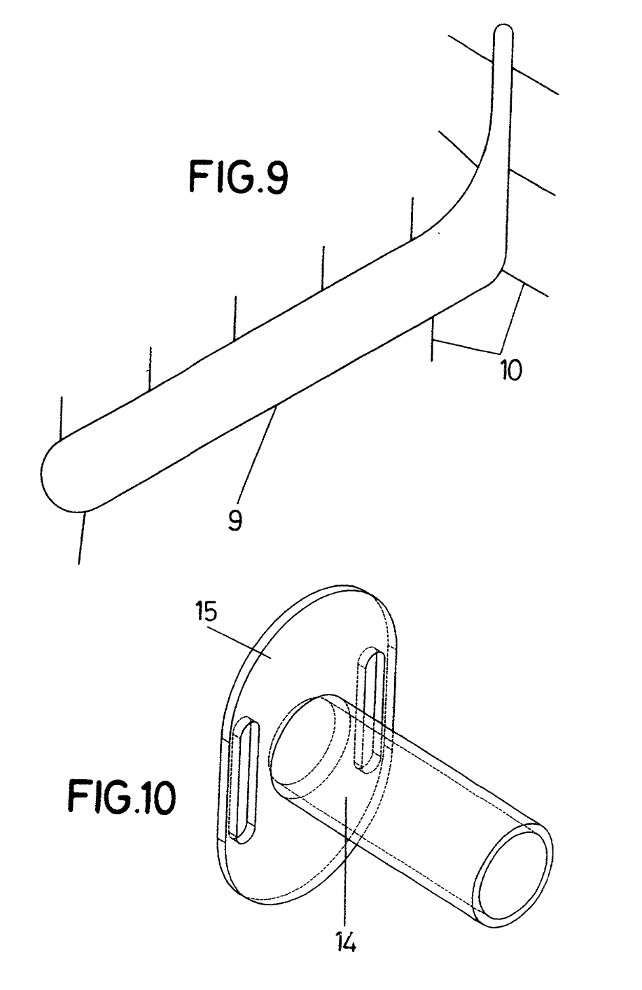

However, and in accordance with the variation on the embodiment shown in FIG. 6, we have foreseen that the oven should contain a single oven, shown with reference number (6) in this figure, represented in detail in FIGS. 7 to 10. This oven is based on a rack (7), of constant width. At one of the lower tips of the rack, there is a pair of gears (8) that act as positioners for the edge of a conveyor belt (9), obviously double, with various transversal trays (10), where the respective rolls are to be placed. This conveyor belt closes in on itself with the aid of another pair of gears (11) situated on the opposite end of the rack (7) and at a considerably greater height, as may be seen especially in FIG. 8, so that the conveyor belt follows an obtuse angular route as may be seen in FIG. 8, with the collaboration of an upper arched rail (12), situated on either side of the oven and another lower rail (13) that acts simultaneously as a tensioner.

In accordance with what has already been explained, the rolls are situated on the trays (10) and follow a route within the rack (7), passing through two sets of infrared resistors, fitted on corresponding sets of lateral supports (14), whereas each of these, as may be seen in FIG. 10, has a shield (15) to be fixed to the side wall (16) and corresponding to the rack (7) in the oven, and a cylindrical neck corresponding to its own reference (14), receiving the corresponding electrical resistor, not represented in the drawings.

This means that, as may also be seen from observing FIG. 8, in the chosen preferred embodiment, each roll passes over four infrared resistors, uniformly distributed and under three upper resistors, before reaching the inflection area defined by the rail (12), which still maintains for a considerable time the proximity of the roll with the last of the upper resistors, for the most part of the ascending route, until reaching the upper and end gears (11) and by the inflection of the chain (19) over itself, each tray (10) weighs in, depositing the corresponding roll on an exit ramp (17).

The resistors are covered an protected on the upper side by a lid (18), which collaborates with the side walls (16) in the aforementioned closing and they extend as far as a transfer unit (19) upon which the rolls are individually deposited to be heated. By using a motor (20), the transfer unit moves (19) so that each roll is deposited on the corresponding tray (10), perfectly synchronised with the conveyor belt (9), which is in turn assisted by a synchronous motor.

Lastly, we only need to indicate that there is a grating (21) under the transfer unit (19) for gas release, and that under the conveyor belt (9) with its trays (10), there is a tray (22) to collect the breadcrumbs, accessible though a trap door (23) situated on the edge of the oven corresponding to ramp (17) where the hot rolls are delivered and situated under the aforementioned ramp.

What is claimed:

1. Vending machine for hot rolls, of the type that are prefabricated whereas the bread has not yet finished cooking, wrapped in a thermoresistant plastic bag that is filled with inert gas and later subjected to a freezing process and preserved in refrigeration. This machine is characterised by the fact that it includes a refrigerated area, similar to a fridge, in the postero-superior part of same, where there are various storage trays for the rolls. Each of these is materialised on a helicoid, placed on its vertical axis. This helicoid is intended to receive a roll between each adjacent pair of spirals in same. It is assisted by a geared motor which is able to turn the helicoid on its own axis. Each time it turns, one of the rolls stored in the corresponding support is released and supplied to a lower heating area or oven, by means of a transfer element between the refrigeration area and the heating area or oven. The machine may include one or two heating ovens. In the case of one single oven, there is a lower conveyor belt system at a slope to transport the rolls between the heating elements. This embodiment is characterised by the fact that the helicoids (1a) that support and release the rolls one by one from the vertical piles, are placed between a couple of partitions that determine the space corresponding to each roll and guide the rolls downwards as the helicoid (1a) turns. It is also intended, with the heating oven(s) (2-6), to include a mechanism (5) that will allow the roll to be extracted from the respective oven without allowing the user to access the inside of the oven.

2. Vending machine for hot rolls, according to the 1^{st} claim, characterised because when the machine has two ovens (2), there is a transfer element (4), consisting of a hollow, cylindrical, rotating element, assisted by a geared motor and two end stops, with at least one space on its surface for a roll. This cylinder should be able to face this space to the bottom of the hopper at the refrigeration zone or to any of the channels communicating with the ovens (2), keeping the refrigeration zone insulated from the heating areas or ovens.

3. Vending machine for hot rolls, according to the 1^{st} claim, characterised by the fact that when it includes a single oven (6), the corresponding conveyor belt (9) contains a series of trays (10), supporting the respective rolls. The aforementioned conveyor belt (9) is obtusely and roundly bent on exit, forced by arched rails (12) and (13), the latter with a tensioning function, so that the operative sector of the aforementioned conveyor belt (9) follows a terminal route, first curved and later rising, maintaining its proximity with the last infrared resistor used as the means for heating, for a longer period of time.

4. Vending machine for hot rolls, according to the 3^{rd} claim, characterised by the fact that the aforementioned conveyor belt (9) run by a motor (20), moves parallel and synchronised to a transfer unit (19), assisted by its own motor which, having received the rolls individually for heating, deposits them correctly on the respective trays (10) of the conveyor belt (9).

5. Vending machine for hot rolls, according to the 3rd and 4th claims, characterised by the fact that the heating area or oven (6) contains an antero-inferior grating (21) for the release of gases, with a ramp (17) where the hot rolls come out in the upper part of its other end, and under this ramp (17) with a trap door (23) which allows access to a tray for collecting breadcrumbs (22), situated under the conveyor belt (9).
